(19) United States
(12) Patent Application Publication
(10) Pub. No.: US 2006/0253728 A1
(43) Pub. Date: Nov. 9, 2006

(54) Server switchover in data transmissions in real time

(76) Inventor: Richard Gemon, Paris (FR)

Correspondence Address: BLANK ROME LLP, 600 NEW HAMPSHIRE AVENUE, N.W., WASHINGTON, DC, 20037, US

(21) Appl. No.: 11/415,421

(22) Filed: May 2, 2006

(30) Foreign Application Priority Data
May 4, 2005 (FR) 0504573

(51) Int. Cl. G06F 11/00

(52) U.S. Cl. 714/4

(57) ABSTRACT

A method of backing up data streams coming from a single source via different transmission channels including at least a first server and a second server and a filter for transmission in real time of a single data stream from said first server to a customer station, includes detecting an anomaly in the webcasting of the data stream coming from the first server.

The present invention relates to the field of data transmission via one or more servers.

The present invention relates more particularly to a method of backing up a data stream by a mechanism for detecting transmission problems in a multi-server environment, and to a solution to such transmission failure.

Such data stream backup or “failover” systems are already known from the prior art. For example, U.S. Pat. No. 6,490,610 (Oracle Corporation) describes a mechanism for correcting transmission errors when accessing resources via a server. In particular that document discloses a failover method for recovering a data stream after transmission failure of a first server to which the customer was connected for accessing the resources. When such a connection failure is detected, the customer is automatically connected to a second server having access to the same resources. By way of example, that mechanism is explained for a connection between a customer and a database server. With that automatic failover mechanism, it is not necessary to log back into the database every time the transmission through the first server fails. That mechanism uses marking of the state of a database during a transmission. Thus, when a customer makes a request to the database, that database state as from which the data will be transferred is transmitted in response to the request in the form of a timestamp. The data is then transmitted on the basis of said timestamp. In the event that the connection fails, the customer detects the failure and sends the timestamp to a second server so as to recover the data corresponding to the timestamp.

It can thus be understood that that mechanism can operate only if the communication between the database and the customer is a both-way communication, because the customer informs the database of the instant at which the failure took place.

In a one-way communication, e.g. for communications from a stock market, that mechanism is thus not possible.

An object of the present invention is thus to solve the problem of backing up a stream in a one-way transmission between a data source and a customer via a set of servers.

However, it should be noted that the solution is also applicable in a both-way transmission for recovering data in real time.

An object of the present invention is thus to remedy the drawbacks of the prior art by enabling such real-time failover to take place even if the communication is one-way.

To this end, the present invention is of the type described above, and it is remarkable, in its broadest acceptation, in that it provides a method of backing up data streams coming from a single source via different transmission channels comprising at least a first server and a second server, and a filter for transmission in real time of a single data stream from said first server to a customer station, said method comprising the following steps:
for said filter, detecting an anomaly in the webcasting of the data stream coming from the first server, this step comprising the following sub-steps:
analyzing the data received from the channels coming from said first and second servers; and
comparing the data coming from said first and second servers and, if the first server is inactive for a fixed lapse of time (S) while the second server is active for said fixed lapse of time (S), switching over to said second server, for transmitting a single data stream coming from said second server, said fixed lapse of time (S) being at least equal to the longest accepted latency between said first server and said second server; and
transmitting the data in real time from the second server.

Preferably, after the switchover to said second server, the data from said second server at the time of the switchover is supplied.

In this way, it is possible to guarantee the state of the data at the time of the switchover, even if it is not updated subsequently. This thus prevents data from being lost at the time of the switchover from the first server to the second server.

Preferably, said comparison step is performed by sampling, and, for example, in Boolean manner, at a predetermined period (T) shorter than said fixed lapse of time (S).

This makes it simple to analyze and compare the signals coming from the first and second servers.

The method of the invention is particularly suitable when said items of data are of the transient type that are pertinent only at the time at which they are transmitted, and when said data stream is one-way from the data source to said customer station.

The invention also provides a computer program, optionally stored on a data storage medium, for implementing the method of the invention.

The invention will be better understood on reading the following description of an implementation of the present invention, given merely by way of explanation and with reference to the accompanying drawings, in which:

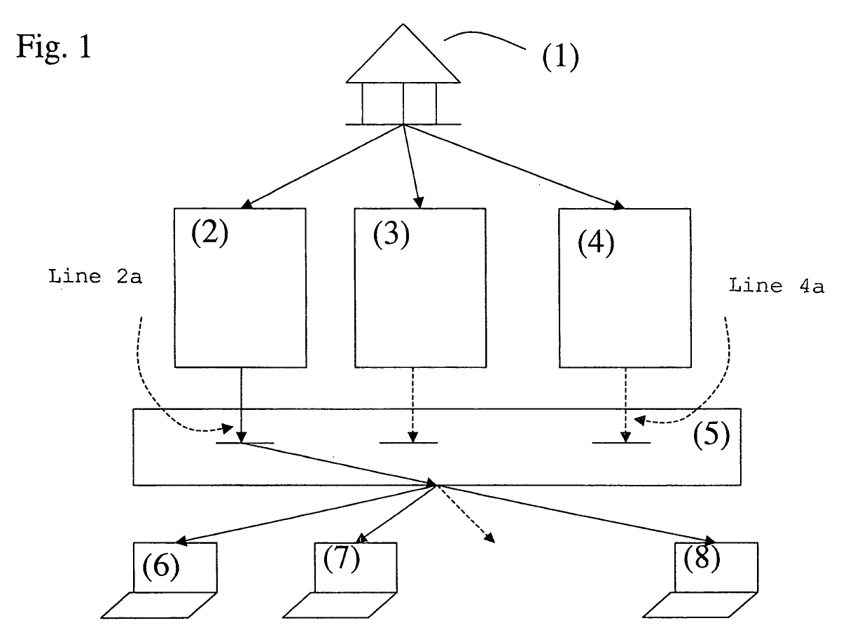

FIG. 1 is an example of architecture in which the invention is implemented in a first state;

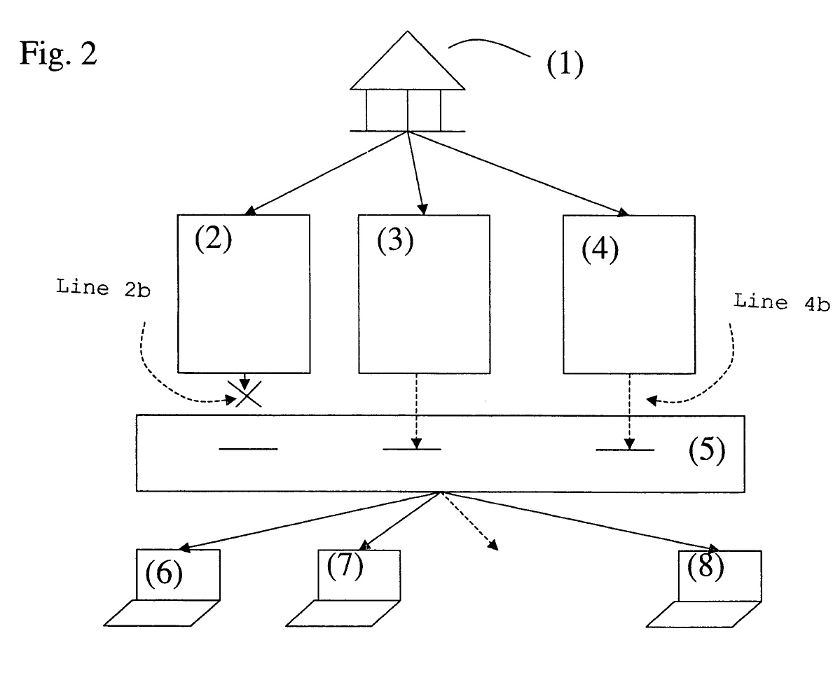

FIG. 2 is an example of architecture in which the invention is implemented in a second state;

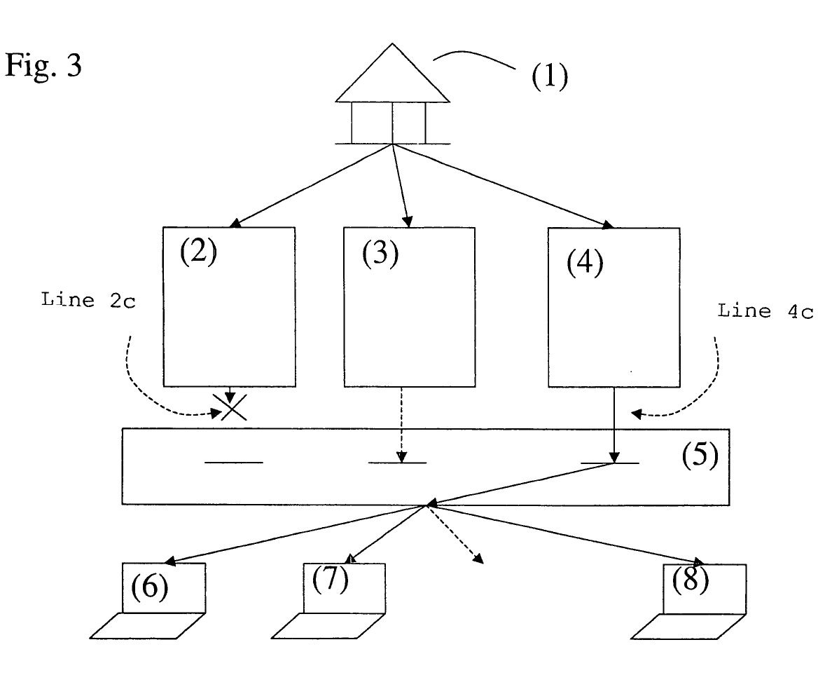

FIG. 3 is an example of architecture in which the invention is implemented in a third state;

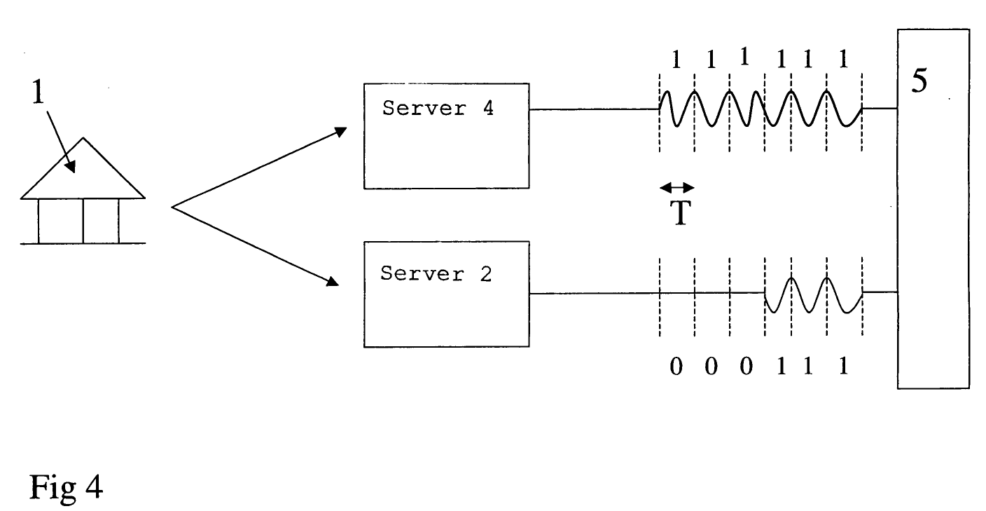

FIG. 4 shows an implementation of the invention by continuous and Boolean comparison of the signals of the channels;

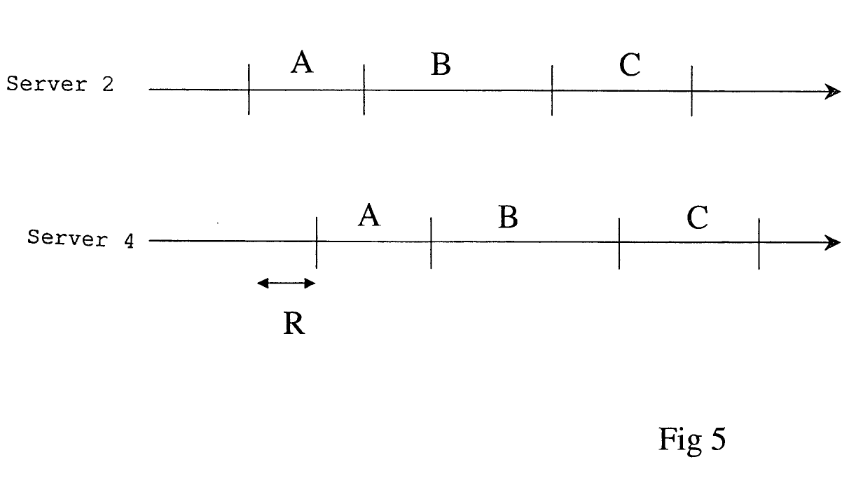

FIG. 5 is a representation of data reception of the invention, showing sporadic delays; and

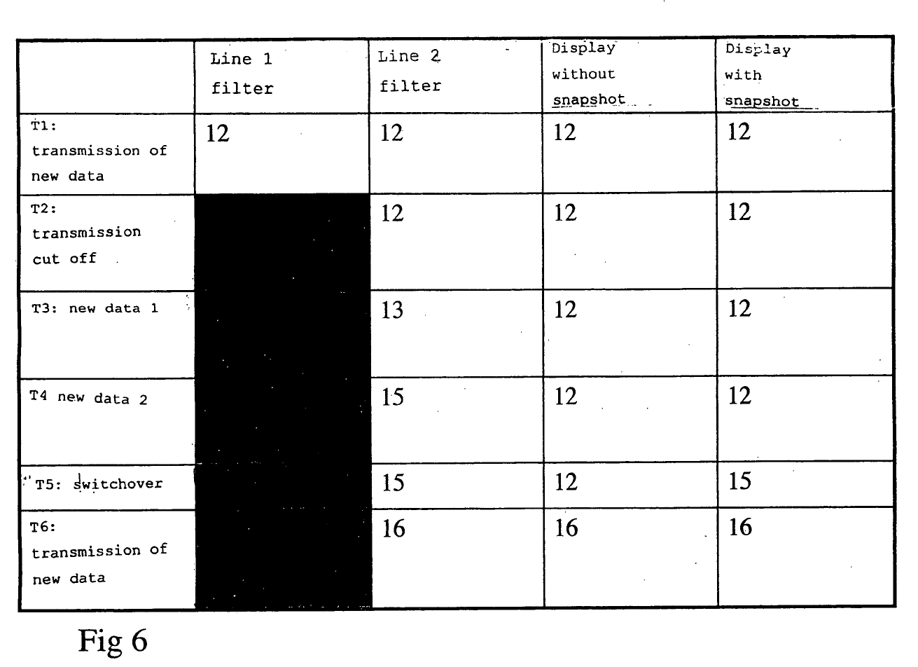

FIG. 6 is a table showing the advantages of supplying the data coming from the server at the time of switchover.

As shown in FIG. 1, the architecture of the invention includes a resource transmitter 1 for transmitting resources in the form of a data stream. For example, the transmitter is a stock market, but the person skilled in the art can understand that the invention is not limited to this type of source, and that it is applicable to any type of source.

The source 1 is connected to a set of servers 2, 3, 4, e.g. via a one-way link when no data can be transmitted to the source, and in particular for transient data that is pertinent only at a fixed instant, i.e. for a continuous data stream.

Communications lines are also defined coming from the servers. Consideration is given to an “active” line for which the filter 5 transmits the data received from the “active” server to the customer sets or workstations 6, 7, and 8.

In FIG. 1, it is thus considered that the server 2 is active while the servers 3 and 4 are backup servers designed to perform the data transfer in the event that the server 1 fails. The line 2a is an active line and the line 4a is an inactive line. The data from the inactive lines is blocked by the filter 5 which does not transmit it to the workstations 6, 7, and 8. For the purposes of the present application, it is considered that the servers are active or in service when they are capable of transmitting the data once they have received it from the source.

A server becomes out of service or “down” when it no longer transmits the data to the filter 5 for a predefined period of time. Naturally, the filter 5 is suitable for determining whether or not it is receiving data from one or other of the servers.

In FIG. 2, the active line 2a of FIG. 1 has become an out-of-service line 2b by an interruption in the transfer between the server 2 and the filter 5.

In an implementation, in order to check that the data stream is received properly, a reception check is performed by the filter 5 per period of time T.

During the check, various situations are then possible:

If the active line 2a has received the data from the source 1, it still remains active (FIG. 1).

If the line 2a has not received any data from the server 2, it becomes out of service (line 2b of FIG. 2).

In which case, if there is at least one backup line in service (such as the line 4b), then the following rule is applied.

If the active line 2a is out of service for N consecutive time periods T, and if N reaches a predefined threshold of the “inactivity maximum” type, then the highest-priority backup line becomes the active line (e.g. line 4c associated with the server 4 in FIG. 3). In which case, the source 1 still remains active, via the server 4 as in FIG. 3. This thus means that the filter transmits the data coming from the server 4 to the workstations 6, 7, 8, the data from the server 3 remaining blocked and the corresponding line remaining inactive.

If the inactivity time threshold N*T is not reached, the switchover does not take place, and the source remains inactive. It should be noted that the switchover can take place at a subsequent period when the threshold is reached, or indeed the connection is re-established, and the server 2 then remains the active server.

In this implementation, the items of data transmitted by the servers are thus compared in Boolean and continuous manner. As shown in FIG. 4, the filter 5 analyses and compares the received signals. It thus detects that, for 3 periods T, the server 2 did not transmit any data (first three Boolean values at 0) while the server 4 did transmit data (first three Boolean values at 1). Depending on the predefined inactivity threshold, the server 2 is or is not switched over to the server 4. It is then understood that, if N is chosen to be less than or equal to 3, the switchover will take place, and if N is strictly greater than 3, the switchover will not take place.

It is also noted that if the active line is no longer transmitting data and if no other line is transmitting data (Boolean values 0 on both channels), it is considered that the source is no longer transmitting any information (e.g. if a stock exchange is no longer transmitting during a break or pause), and the switchover is not performed.

In order to determine the check parameters, firstly the reception check sampling period SamplingPeriod=T is defined.

The maximum allowed non-reception delay InactivityDelay=S during which no reception takes place is also defined.

The maximum allowed number MaxInacPeriod of periods T allowed for non-reception, N=Max{n, nT ≦s, where n is an integer} is determined.

In order to implement the invention, a list of line numbers is defined that is pre-classified in decreasing order of priority (e.g. on the basis of the stability observed for certain servers, or on the basis of any other criterion, e.g. the mean latency observed). The first line in the list will then initially be the active line (line 2a in FIG. 1).

Depending on the variants chosen, it should be understood that it is also possible to define one InactivityDelay parameter per line, or indeed to choose one parameter that is common to all of the lines, it being possible, for example, for S to be 30 seconds, in the context of a real-time stock market transmission.

For example, the method is implemented by a stream delay counter which is incremented whenever a line has not been fed over a period T, and when at least one passive line has been fed over the same period. If the delay counter reaches the maximum allowed value, the active line goes over to the passive state, and then the passive line that was fed over the period and that has the highest priority goes over to the active state.

An implementation is described above in which the maximum acceptable time for the difference between the two channels before switchover is sampled at a period T and determined in Boolean manner, but it should be understood that any type of comparison can be made between the data of the channels coming from the various servers.

In particular, it is possible to compare the signals directly over the time S, in continuous manner or using variable sampling.

In the invention, it is also important to determine the parameters that are acceptable in the context of a real-time data transmission such as a stock market data transmission.

FIG. 5 shows an example of a data stream received by the server 2 and by the server 4. It is known that there exists a sporadic delay R, also referred to as the “latency time”, between the two streams, as shown in FIG. 5, for transmission of the frames A, B, and C. For example, this delay is due to the various data processing between the source and the various servers, or indeed to the processing at the servers. Thus, it can be understood that if the chosen maximum time S accepted for difference between the channels before switchover is too short, a switchover will be performed even though the difference is due to a sporadic delay.

The maximum allowed non-reception delay S is thus chosen such that S is greater than or equal to the maximum accepted latency time R₀.

In the implementation in which the comparison is sampled at a period T, switchover is chosen to take place when the Boolean analysis gives N times the value 0 on one line and N times the value 1 on another, where N=Max{n, nT≦s, where n is an integer} and S≧R₀.

Thus, such a choice for the parameter S makes it possible to take full account of the latency delays between the streams transmitted by the various servers.

After the switchover, the server 4 then corresponds to the active line. But it is important to note that the filter does not necessarily transmit the value of an item of data stored in a memory at the time of the switchover, since said item of data is blocked before the switchover.

Preferably, a copy or “snapshot” of the state of the data of the server 4 that is now active is taken at the time of the switchover, and said snapshot is transmitted to the customer workstations by the filter 5.

After said snapshot has been taken, the data from the source is then transmitted in real time by the active line in the proper manner.

In this way, it is guaranteed that the values of the items of data in their final states at the time of the switchover are correct, whereas, without such a snapshot, only those items of data which are refreshed subsequently are guaranteed.

It should be noted that such a snapshot can be important in the context of stock market data transmission. As shown in the table in FIG. 6, an active line 2 and an initially inactive line 4 are considered. The filter thus receives the value 12 from the two servers as can be seen in columns 2 and 3 of the table, and it transmits the items of data from the active server 2. The display is then given in column 3 and column 4, and, naturally, the value 12 is displayed on the customer workstation.

In the event that the line 2 fails at time T2, so long as the switchover is not effected, a new item of data obtained at time T3 by the line 4 in service is then, naturally, not displayed and not transmitted to the customer workstation.

In the same way, a new item of data obtained at T4 is not transmitted.

If the switchover takes place at T5, without a snapshot being taken of the memory of the server, the new item of data whose value is 15 is not displayed because the filter has blocked said value.

With a snapshot of the state of the server, the item of data 15 is transmitted and displayed at the time of the switchover.

The importance of this implementation can then be understood if the time between the switchover to line 4 at T5 and the obtaining of a new item of data of the line 4 at T6 is long. Throughout that time, the user then believes that the value of the item of data is 12 (value at the time of interruption of the link of the server 2) whereas it is actually at 15 (value at the time of the switchover to server 4).

In a stock market data context in which the real-time data items are of the highest importance, the use of the present invention thus makes it possible to minimize losses of information during transmission cuts.

The invention is described above by way of example. Naturally, the person skilled in the art can implement different variants of the invention without going beyond the ambit of the patent.

1. A method of backing up data streams coming from a single source via different transmission channels comprising at least a first server, a second server, and a filter for transmission in real time of a single data stream from said first server to a customer station, said method comprising:
detecting an anomaly in the webcasting of the data stream coming from the first server including,
comparing the data coming from said first and second servers and, if the first server is inactive for a fixed lapse of time while the second server is active for said fixed lapse of time, switching over to said second server, for transmitting a single data stream coming from said second server, said fixed lapse of time being at least equal to the longest accepted latency between said first server and said second server; and
transmitting the data in real time for the second server.

2. A method according to claim 1, wherein after the switchover to said second server, the data from said second server at a time of the switchover is supplied.

3. A method according to claim 1, wherein the comparing is performed by sampling according to a predetermined period shorter than said fixed lapse of time.

4. A method according to claim 3, wherein the comparing is performed in Boolean meaner by sampling according to said predetermined period.

5. A method according to claim 4, wherein said data are pertinent only at the time of transmission.

6. A method according to claim 5, wherein said data stream is one-way from at least one of the first server and the second server to said customer station.

7. A computer program for implementing the method according to claim 6, further comprising instructions for performing said detecting and comparing.

8. A method according to claim 2, wherein the comparing is performed by sampling according to a predetermined period shorter than said fixed lapse of time.

9. A method according to claim 8, wherein the comparing is performed in Boolean meaner by sampling according to said predetermined period.

10. A method according to claim 1, wherein said data are pertinent only at the time of transmission.

11. A method according to claim 2, wherein said data are pertinent only at the time of transmission.

12. A method according to claim 3, wherein said data are pertinent only at the time of transmission.

13. A method according to claim 1, wherein said data stream is one-way from at least one of the first server and the second server to said customer station.

14. A method according to claim 2, wherein said data stream is one-way from at least one of the first server and the second server to said customer station.

15. A method according to claim 3, wherein said data stream is one-way from at least one of the first server and the second server to said customer station.

16. A method according to claim 4, wherein said data stream is one-way from at least one of the first server and the second server to said customer station.

17. A computer program for implementing the method according to claim 1, further comprising instructions for performing said detecting and comparing.

18. A computer program for implementing the method according to claim 2, further comprising instructions for performing said detecting and comparing.

19. A computer program for implementing the method according to claim 3, further comprising instructions for performing said detecting and comparing.

20. A computer program for implementing the method according to claim 4, further comprising instructions for performing said detecting and comparing.
